(19) United States
(12) Patent Application Publication
(10) Pub. No.: US 2015/0302784 A1
(43) Pub. Date: Oct. 22, 2015

(54) INFORMATION PROCESSING SYSTEM, CONTROL METHOD, AND COMPUTER-READABLE MEDIUM

(71) Applicants: NEC Corporation, Tokyo (JP); NEC Solutions Innovators, Ltd., Tokyo (JP)

(72) Inventors: Noriyoshi HIROI, Tokyo (JP); Nobuaki TAKANASHI, Tokyo (JP); Yoshiaki SATO, Tokyo (JP); Hiroyuki WATANABE, Tokyo (JP); Takafumi KUROKAWA, Tokyo (JP); Kenji AKIYOSHI, Tokyo (JP); Ryohtaroh TANIMURA, Tokyo (JP)

(73) Assignees: NEC CORPORATION, Tokyo (JP); NEC SOLUTION INNOVATORS, LTD., Tokyo (JP)

(21) Appl. No.: 14/688,162

(22) Filed: Apr. 16, 2015

(30) Foreign Application Priority Data
Apr. 18, 2014 (JP) 2014-086511

(51) Int. Cl. G09F 27/00

(52) U.S. Cl. CPC G09F 27/005; G09F 2027/001

(57) ABSTRACT

An information processing system, method and non-transitory computer-readable storage medium are disclosed. The information processing system may include a memory storing instructions; and one or more processors configured to process the instructions to detect an actual object, project a first image, detect a user's operation on the actual object, and execute a task regarding the first image on the basis of the user's operation.

### CROSS-REFERENCE TO RELATED PATENT APPLICATION

This application is based upon and claims the benefit of priority from Japanese Patent Application No. 2014-086511, filed on Apr. 18, 2014, the disclosure of which is incorporated herein in its entirely by reference.

### BACKGROUND

1. Technical Field

The present disclosure generally relates to an information processing system, a control method, and a computer-readable medium.

2. Description of the Related Art

Digital signages that advertise media for displaying images and information using display devices, projectors, and the like may have been known. Some digital signages may be interactive in that their displayed contents are changed in accordance with the operations of users. For example, there may be a digital signage in which, when a user points at a marker in a brochure, contents corresponding to the marker are displayed on a floor or the like.

An interactive digital signage may accept an additional input that a user gives in accordance with information displayed by the digital signage. In such a way, the digital signage may be realized more interactively. Although the related art displays contents corresponding to a marker pointed at by a user, it is difficult for the art to deal with an operation further given by a user in accordance with the displayed contents.

In some instances, a projected image may be used as an input interface. However, because an operation on a projected image is not accompanied by the feeling of operation, it is difficult for a user to have the feeling of operation, and the user may feel a sense of discomfort.

### SUMMARY OF THE DISCLOSURE

Exemplary embodiments of the present disclosure may solve one or more of the above-noted problems. For example, the exemplary embodiments may provide a new user interface in a system in which information is presented by projecting images.

According to a first aspect of the present disclosure, an information processing system is disclosed. The information processing system may include a memory storing instructions; and one or more processors configured to process the instructions to detect an actual object, project a first image, detect a user's operation on the actual object and execute a task regarding the first image on the basis of the user's operation.

An information processing method according to another aspect of the present disclosure may include detecting an actual object, projecting a first image, detecting a user's operation on the actual object, and executing a task regarding the first image on the basis of the user's operation.

A non-transitory computer-readable storage medium may store instructions that when executed by a computer enable the computer to implement a method. The method may include detecting an actual object, projecting a first image, detecting a user's operation on the actual object, and executing a task regarding the first image on the basis of the user's operation.

In certain embodiments, the information processing system, the control method, and the computer-readable medium may provide a new user interface that provides information by projecting images.

### BRIEF DESCRIPTION OF THE DRAWINGS

FIG. 1 is a block diagram illustrating an information processing system of a first exemplary embodiment.

FIG. 2 is a block diagram illustrating the hardware configuration of the information processing system of the first exemplary embodiment.

FIG. 3 is a diagram illustrating a device made by combining a projection device and a monitoring device.

FIG. 4 is a flowchart depicting a flow of processing executed by the information processing system of the first exemplary embodiment.

FIG. 5 is a diagram illustrating an assumed environment in a first example.

FIG. 6 is a plan view illustrating a state of a table around a user in the first example.

FIG. 7 is a diagram illustrating the information processing system of the first exemplary embodiment including an image obtaining unit.

FIG. 8 is a diagram illustrating a usage state of the information processing system of the first exemplary embodiment.

FIG. 9 is a block diagram illustrating an information processing system of a second exemplary embodiment.

FIG. 10 is a block diagram illustrating the information processing system of the second exemplary embodiment including an association information storage unit.

FIG. 11 is a flowchart depicting a flow of processing executed by the information processing system of the second exemplary embodiment.

FIG. 12 is a block diagram illustrating an information processing system of a third exemplary embodiment.

FIG. 13 is a flowchart depicting a flow of processing executed by an information obtaining device of the third exemplary embodiment.

FIG. 14 is a diagram illustrating a state of a ticket, which is used for downloading contents, being output from a register terminal.

FIG. 15 is a block diagram illustrating an information processing system of a fourth exemplary embodiment.

FIG. 16 is a flowchart depicting a flow of processing executed by the information processing system of the fourth exemplary embodiment.

FIG. 17 is a block diagram illustrating an information processing system of a fifth exemplary embodiment.

FIG. 18 is a plan view illustrating a state on a table in a fourth example.

FIG. 19 is a block diagram illustrating a combination of an information processing system and a Web system.

### DETAILED DESCRIPTION

Hereinafter, embodiments of the present disclosure will be described with reference to the accompanying drawings. Wherever possible, the same reference numbers will be used throughout the drawings to refer to the same or like parts.

### First Exemplary Embodiment

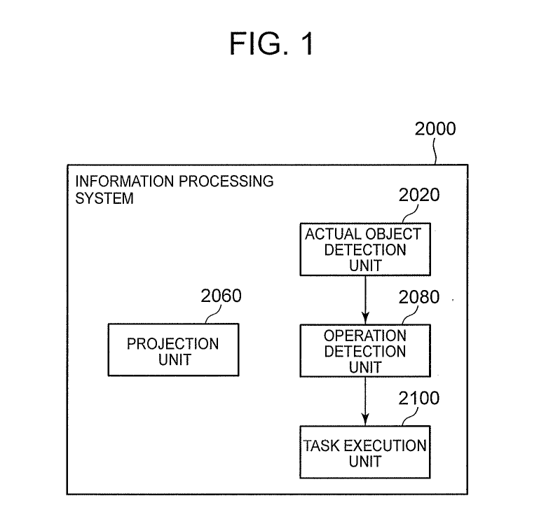

FIG. 1 is a block diagram illustrating an information processing system 2000 of a first exemplary embodiment. In FIG. 1, arrows indicate a flow of information. Each block in FIG. 1 does not indicate the configuration of a hardware unit, but indicates the configuration of a functional unit.

In certain aspects, the information processing system 2000 may include an actual object detection unit 2020, a projection unit 2060, an operation detection unit 2080, and a task execution unit 2100. The actual object detection unit 2020 may detect an actual object. The actual object may be the entirety of an actual object or a part of an actual object. Further, in additional aspects, the actual object to be detected by the actual object detection unit 2020 may be one or more. The projection unit 2060 may project a first image. The projection unit 2060 may project one or more images. The operation detection unit 2080 may detect a user's operation on an actual object. A task execution unit 2100 may execute a task regarding the first image on the basis of the user's operation.

### <Hardware Configuration>

The respective functional components of the information processing system 2000 may be realized by hardware components (for example, hard-wired electronic circuits and the like) to realize the functional components. In other instances, the respective functional components of the information processing system 2000 may be realized by a combination of hardware components and software components (e.g., a combination of electronic circuits and a program to control those circuits, and the like).

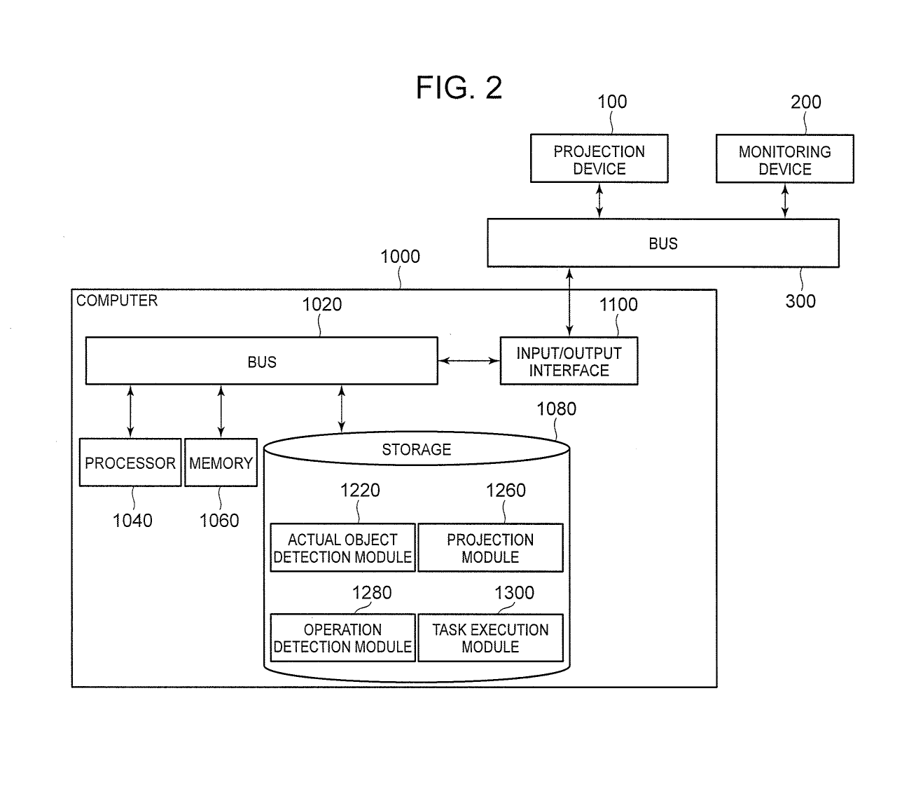

FIG. 2 is a block diagram illustrating a hardware configuration of the information processing system 2000. In FIG. 2, the information processing system 2000 may be realized with a projection device 100, a monitoring device 200, a bus 300, and a computer 1000. The projection device 100 may project an image. The projection device 100 may be a projector, for example. The monitoring device 200 may monitor its surroundings. The monitoring device 200 may be a camera, for example. The computer 1000 may be any of various types of computers, such as a server and a PC (Personal Computer). The bus 300 may include a data transmission path through which data is transmitted and received among the projection device 100, the monitoring device 200, and the computer 1000. In some aspects, the connection among the projection device 100, the monitoring device 200, and the computer 1000 to each other may not be limited to the bus connection.

### <<Detail of the Computer 1000>>

In certain aspects, the computer 1000 may include a bus 1020, a processor 1040, a memory 1060, a storage 1080, and an input/output interface 1100. The bus 1020 may include a data transmission path through which data is transmitted and received among the processor 1040, the memory 1060, the storage 1080, and the input/output interface 1100 to and from each other. In some aspects, the connection among the processor 1040 and others to each other may not be limited to the bus connection. The processor 1040 may include, for example, an arithmetic processing unit such as a CPU (Central Processing Unit) and a GPU (Graphics Processing Unit). The memory 1060 may include, for example, a memory such as a RAM (Random Access Memory) and a ROM (Read Only Memory). The storage 1080 may include, for example, a memory device such as a hard disk, an SSD (Solid State Drive) and a memory card. In other aspects, the storage 1080 may be a memory such as a RAM and a ROM. The input/output interface 1100 may include an input/output interface to transmit and receive data between the projection device 100 and the monitoring device 200 through the bus 300.

The storage 1080 may store an actual object detection module 1220, a projection module 1260, an operation detection module 1280, and a task execution module 1300 as programs for realizing the functions of the information processing system 2000.

The actual object detection unit 2020 may be realized by a combination of the monitoring device 200 and the actual object detection module 1220. In some aspects, the monitoring device 200 may include a camera, and the actual object detection module 1220 may obtain and may analyze an image captured by the monitoring device 200, for detecting an actual object. The actual object detection module 1220 may be executed by the processor 1040.

The projection unit 2060 may be realized by a combination of the projection device 100 and the projection module 1260. In some instances, the projection module 1260 may transmit information indicating a combination of “an image to be projected and a projection position onto which the image is projected” to the projection device 100. The projection device 100 may project the image on the basis of the information. The projection module 1260 may be executed by the processor 1040.

The operation detection unit 2080 may be realized by a combination of the monitoring device 200 and the operation detection module 1280. In some aspects, the monitoring device 200 may include a camera, and the operation detection module 1280 may obtain and analyze an image photographed by the monitoring device 200, for detecting a user's operation conducted on an actual object. The operation detection module 1280 may be executed by the processor 1040.

In some instances, the processor 1040 may execute the above modules, and the processor 1040 may execute these modules with these modules being read out on the memory 1060. In other instances, the processor 1040 may execute the above modules, and the processor 1040 may execute these modules without these modules being read out on the memory 1060.

The hardware configuration of the computer 1000 may not be limited to the configuration illustrated in FIG. 2. In some aspects, the respective modules may be stored in the memory 1060. Further, the computer 1000 may not need to include the storage 1080.

### <<Details of the Projection Device 100 and the Monitoring Device 200>>

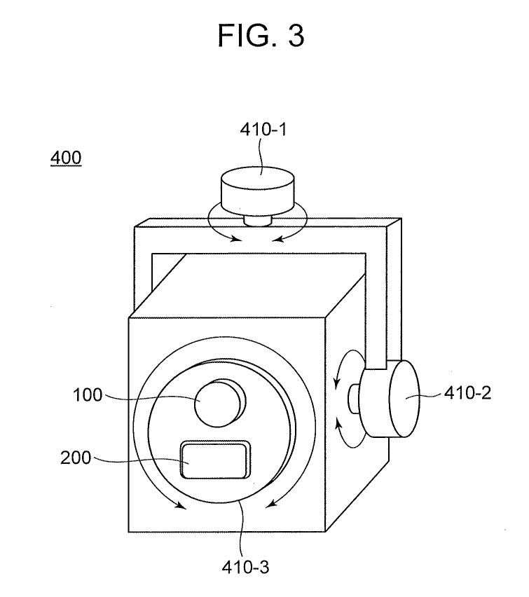

FIG. 3 is a diagram illustrating a device 400. The device 400 illustrated in FIG. 3 may include the projection device 100, the monitoring device 200, and a projection direction adjustment unit 410. The projection direction adjustment unit 410 may include a combination of projection direction adjustment units 410-1, 410-2, and 410-3. In some aspects, the projection direction of the projection device 100 may coincide with or differ from the monitoring direction of the monitoring device 200. In other aspects, a projection range of the projection device 100 may coincide with or differ from a monitoring range of the monitoring device 200.

In some aspects, the projection device 100 may be a visible light projection device or an infrared light projection device, and may project an arbitrary image onto a projection surface by outputting lights that represent predetermined patterns and characters or any patterns and characters.

In some aspects, the monitoring device 200 may include one of or a combination of more than one of a visible light camera, an infrared light camera, a range sensor, a range recognition processing device, and a pattern recognition processing device. In some aspects, the monitoring device 200 may be a combination of a camera, which is used for photographing spatial information in the forms of two-dimensional images, and an image processing device, which is used for selectively extracting information regarding an object from these images. Further, in some aspects, an infrared light pattern projection device or an infrared light camera may obtain spatial information on the basis of the disturbances of patterns and the principle of triangulation. Additionally or alternatively, the monitoring device 200 may obtain information in the direction of depth, as well as planar information, by taking photographs from plural different directions. Further, in some aspects, the monitoring device 200 may obtain spatial information regarding an object by outputting a very short light pulse to the object and measuring the time required for the light to be reflected by the object and returned.

The projection direction adjustment unit 410 may be configured to be capable of adjusting a position of an image projected by the projection device 100. In some aspects, the projection direction adjustment unit 410 may have a mechanism used for rotating or moving all or some of devices included in the device 400, and may adjust (or move) the position of a projected image by changing the direction or position of light projected from the projection device 100 using the mechanism.

In some aspects, the projection direction adjustment unit 410 may not be limited to the configuration illustrated in FIG. 3. In some instances, the projection direction adjustment unit 410 may be configured to be capable of reflecting light output from the projection device 100 by a movable mirror and/or changing the direction of the light through a special optical system. In some aspects, the movable mirror may be included in the device 400. In other aspects, the movable mirror may be provided independently of the device 400. The projection direction adjustment unit 410 may be configured to be capable of moving the projection device 100 itself.

In some instances, the projection device 100 may change the size of a projected image in accordance with a projection surface by operating an internal lens and may adjust a focal position in accordance with a distance to the projection surface. When a line (an optical axis) connecting the center of the projection position of the projection surface with the center of the projection device 100 differs in direction from a line extended in a vertical direction of the projection surface, a projection distance varies within a projection range. Further, the projection device 100 may be realized by a specially designed optical system having a deep focal working distance for dealing with the above circumstances.

In other aspects, the projection device 100 may have a wide projection range, and the projection direction adjustment unit 410 may mask some of light emitted from the projection device 100 and may display an image on a desired position. Further, the projection device 100 may have a large projection angle, and the projection direction adjustment unit 410 may process an image signal, so that light is output only onto a required spot, and may pass the image data to the projection device 100.

The projection direction adjustment unit 410 may rotate and/or move the monitoring device 200 as well as the projection device 100. In some instances, in the case of the example illustrated in FIG. 3, the projection direction of the projection device 100 may be changed by the projection direction adjustment unit 410, and a monitoring direction of the monitoring device 200 may be changed accordingly (that is, the monitoring range may be changed). Further, the projection direction adjustment unit 410 may include a high-precision rotation/position information obtaining device in order to prevent the monitoring range of the monitoring device 200 from deviating from a predetermined region. The projection range of the projection device 100 and the monitoring area of the monitoring device 200 may be changed independently of each other.

The computer 1000 may change the direction of the first image by performing image processing on the first image. Further, the projection device 100 may project the first image received from the computer 1000 without using the projection direction adjustment unit 410 to rotate the first image.

The device 400 may be installed while being fixed to a ceiling, a wall surface or the like, for example. Further, the device 400 may be installed with the entirety thereof exposed from the ceiling or the wall surface. In other aspects, the device 400 may be installed with the entirety or a part thereof buried inside the ceiling or the wall surface. In some aspects, the projection device 100 may adjust the projection direction using the movable mirror, and the movable mirror may be installed on a ceiling or on a wall surface, independently of the device 400.

Further, the projection device 100 and the monitoring device 200 may be included in the same device 400 in the abovementioned example. The projection device 100 and the monitoring device 200 may be installed independently of each other.

Further, a monitoring device used to detect the actual object and a monitoring device used to detect a user operation may be the same monitoring device or may be separately provided monitoring devices.

### <Flow of Processing>

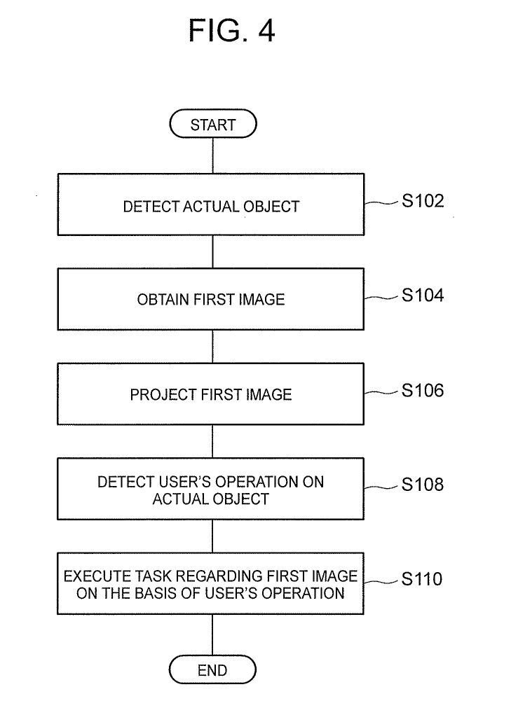

FIG. 4 is a flowchart depicting a flow of processing executed by the information processing system 2000 of the first exemplary embodiment. In step S102, the actual object detection unit 2020 may detect an actual object. In step S104, the information processing system 2000 may obtain a first image. In step S106, the projection unit 2060 may project the first image. In step S108, the operation detection unit 2080 may detect a user's operation on the actual object. In step S110, a task regarding the first image may be executed on the basis of the user's operation.

The information processing system 2000 of the first exemplary embodiment may detect a user's operation on an actual object, and may conduct an operation regarding the projected first image on the basis of the user's operation. As described in this exemplary embodiment, if an actual object is made an input interface, a user may have the feeling of operation conducted on the input interface. In other aspects, if a projected image is made an input interface, a user may not have the feeling of operation conducted on the input interface. In such a way, because this exemplary embodiment may enable a user to have the feeling of operation conducted on an input interface, the input interface may become easy for the user to operate.

If an input interface is an actual object, a user may grasp the position of the input interface by the sense of touch. If an input interface is an image (for example, an icon or a virtual keyboard), a user may not grasp the position of the input interface by the sense of touch. Therefore, because this exemplary embodiment may enable a user to easily grasp the position of an input interface, the input interface may become easy for the user to operate.

If a user conducts an operation while watching an input interface, an actual object may have an advantage in that the actual object is more easily viewable than a projected image. If a projected image is operated as an input interface, a user's hand may overlap a part of the image, and the image especially may become invisible. According to this exemplary embodiment, an input interface may become more easily viewable to a user by making an actual object the input interface. Because, by setting an input interface to a thing other than a projected image, it may become unnecessary to secure an area for displaying the input interface (for example, an area for displaying an icon or a virtual keyboard) in the image, the amount of information regarding the projected image may be increased. Therefore, the projected image may become more easily viewable to the user. Further, the user may easily grasp the functions of the entirety of the system because the image, which is equivalent to an output, and the input interface are separated from each other.

If an actual object is a movable object or a part of a movable object, a user can position the actual object at his/her preferable place. In other words, the user can position the input interface at an arbitrary place. Even seen from this viewpoint, the input interface may become easy for the user to operate.

In some aspects, this exemplary embodiment may provide a new user interface having features in the abovementioned various ways to the information processing system 2000 that projects information in the form of images.

### First Example

In order to more easily understand the information processing system 2000 of this exemplary embodiment, an example of the information processing system 2000 of this exemplary embodiment will be described below. The usage environment and usage method of the information processing system. 2000 that will be described hereinafter are illustrative examples, and they may not limit any other type of usage environments and usage methods of the information processing system 2000. It will be assumed that the hardware configuration of the information processing system 2000 of this example is that illustrated in FIG. 2.

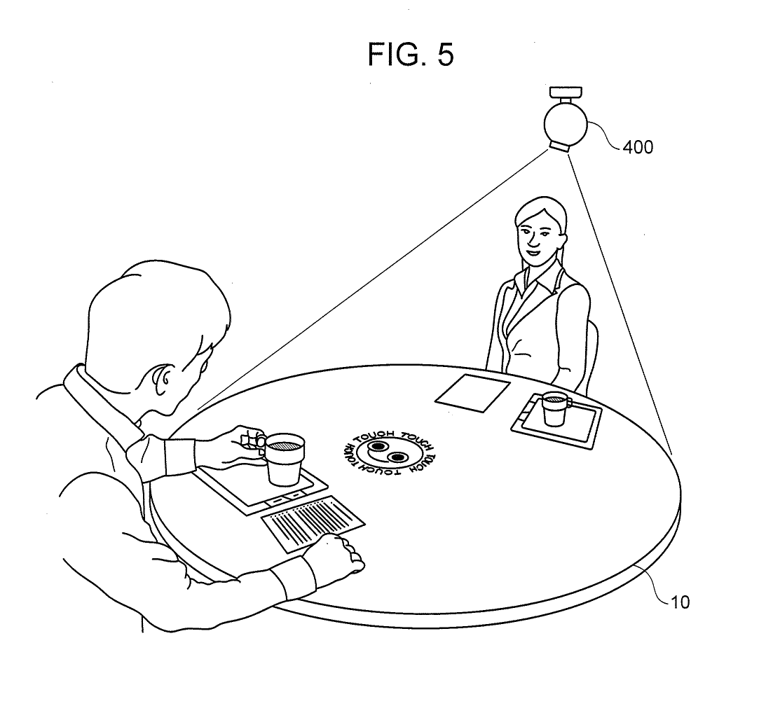

FIG. 5 is a diagram illustrating the usage environment of the information processing system 2000 of this example. The information processing system 2000 may be a system used in a coffee shop, a restaurant or the like. The information processing system 2000 may realize digital signage by projecting images onto a table 10 from a device 400 installed on a ceiling. A user may have a meal or wait for a meal to be served while viewing contents projected onto the table 10 or the like. As is clear from FIG. 5, the table 10 may serve as a projection surface in this example. The device 400 may be installed in a location (e.g., a wall surface) other than a ceiling.

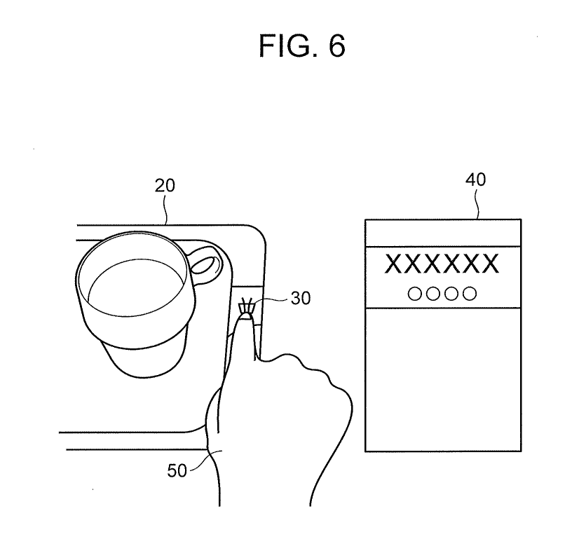

FIG. 6 is a plan view illustrating a state of the table 10 around a user. In FIG. 6, a content image 40 represents a front cover of an electronic book. In some aspects, contents represented by the content image 40 may be not only digital contents such as electronic books but may also be actual objects (analog contents). In other aspects, the contents may be services.

An actual object in this example may be a mark 30. The mark 30 may be attached to a tray 20 on which food and drink to be served to the user are placed. In some instances, the actual object may be other than the mark 30. For example, the actual object may be a mark attached to the table 10 in advance or the like.

It will be assumed that a monitoring device 200 built in the device 400 is a camera. The information processing system 2000 may detect the mark 30 on the basis of an image photographed by the monitoring device 200. Further, the information processing system 2000 may detects a user's operation on the mark 30.

For example, the information processing system 2000 may provide the user with an operation for browsing the content of this electronic book, an operation for bookmarking this electronic book, an operation for purchasing this electronic book or the like. For example, the user may conduct various operations by the user's going over or patting the mark 30 with his/her hand 50.

As described above, according to the information processing system 2000 of this exemplary embodiment, operations on the mark 30 which is an actual object, may be provided to a user as operations for executing tasks regarding the electronic book.

Further, operations that are provided to a user by the information processing system 2000 may not be limited to the examples described above. For example, the information processing system 2000 may provide to the user various operations, such as an operation by which a target content is selected out of plural contents and an operation by which a content is retrieved.

In some aspects, parts of operations provided to a user may be realized by operations conducted on the content image 40. For example, an operation for going over the content image 40 from side to side may be provided to the user as an operation for turning the pages of the electronic book. The information processing system 2000 may analyze the user's operation on the content image 40 which is photographed by the monitoring device 200, and may execute a task corresponding to the user's operation.

### Detail of the First Exemplary Embodiment

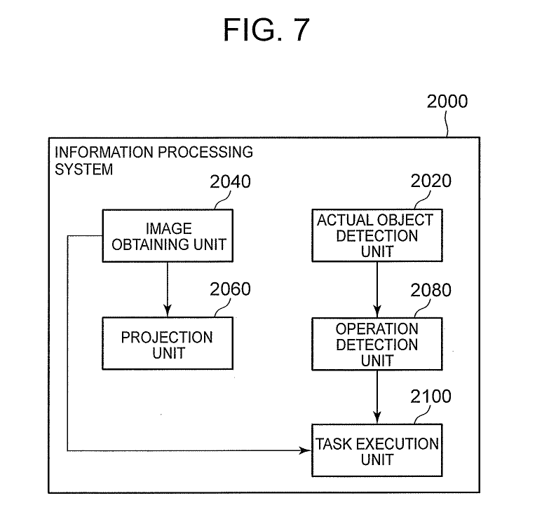

Hereinafter, the information processing system 2000 of this exemplary embodiment will be described in more detail. FIG. 7 is a diagram illustrating the information processing system 2000 of the first exemplary embodiment including an image obtaining unit 2040. In certain aspects, the information processing system 2000 may include an actual object detection unit 2020, an image obtaining unit 2040, a projection unit 2060, an operation detection unit 2080, and a task execution unit 2100.

### <<Detail of the Actual Object Detection Unit 2020>>

The actual object detection unit 2020 may include the monitoring device 200. It will be assumed that “what is detected as an actual object” may be set in the actual object detection unit 2020. The actual object detection unit 2020 may determine whether or not an object that satisfies the set condition is included in the monitoring range of the monitoring device 200. If an object that satisfies the set condition is included, the object may be regarded as an actual object.

In some instances, if the monitoring device 200 is a photographing device, the actual object detection unit 2020 may detect the actual object by performing an object recognition technology on a photographed image generated by the monitoring device 200. As the object recognition technology, a known technology may be applicable.

In some aspects, the monitoring device 200 may be a photographing device compliant with a light other than visible lights (infrared light, ultraviolet light and the like), and an invisible print corresponding to this invisible light may be placed on the actual object. The actual object detection unit 2020 may detect the actual object by performing object recognition on an image including the invisible image printed on the actual object.

A method in which the actual object detection unit 2020 detects an actual object may not be limited to the method in which a photographing device is used. For example, it is assumed that an actual object is a bar code. In some instances, the monitoring device 200 may be realized using a bar-code reader, for example. The actual object detection unit 2020 may detect a bar code which is an actual object, by scanning the projection surface of a first image and vicinities of the projection surface using this bar code reader. As the technology for reading out bar codes, a known technology may be applicable.

In some aspects, the actual object detection unit 2020 may be realized using a distance sensor. The monitoring device 200 may be realized using a laser-type distance sensor, for example. The actual object detection unit 2020 may detect the shape of an actual object and the shape change (distortion) of the actual object with time by measuring a variation of distance to the projection surface of the first image and/or to the vicinities of the projection surface using this laser-type distance sensor. As the technology for reading out the shape and distortion, a known technology may be applicable.

In other aspects, for example, an actual object may be realized by an RF (Radio Frequency) tag, and the information processing system 2000 may recognize the actual object using an RFID (Radio Frequency Identifier) technology. As the RFID technology, a known technology may be applicable.

### <<Method for Obtaining the First Image>>

The information processing system 2000 may include an image obtaining unit 2040 configured to obtain a first image, as illustrated in FIG. 7. There may be various methods in which the image obtaining unit 2040 obtains a first image. In some instances, the image obtaining unit 2040 may obtain a first image input from an external device. In other instances, the image obtaining unit 2040 may obtain a first image to be manually inputted. The image obtaining unit 2040 may access an external device to obtain a first image.

There may be plural first images for one content. In some aspects, a content may be an electronic book, and an image of the front cover and images on individual pages for one electronic book may correspond to plural first images. In other aspects, a content may be an actual object, and images obtained by photographing the actual object from various angles may correspond to plural first images.

### <<Detail of the Projection Unit 2060>>

In some instances, the projection unit 2060 may include the projection device 100 such as a projector that projects images. The projection unit 2060 may obtain the first image obtained by the image obtaining unit 2040, and may project the obtained first image onto a projection surface.

There may be various projection surfaces onto which the projection unit 2060 projects images. In some instances, projection surfaces may include the table. In other instances, projection surfaces may include a wall a floor, and the like. In other instances, projection surfaces may include a part of the human body (e.g., a palm). In other instances, projection surfaces may include apart of or the entirety of an actual object.

### <<Detail of the Operation Detection Unit 2080>>

As is the case with the actual object detection unit 2020, the operation detection unit 2080 may include a monitoring device for monitoring its surroundings. The actual object detection unit 2020 and the operation detection unit 2080 may include one monitoring device in common. The operation detection unit 2080 may detect a user's operation on an actual object on the basis of a monitoring result obtained by the monitoring device.

### <<<Types of User's Operations>>>

There may be many types of user's operations that a user conducts. For example, a user's operation may be conducted by an operation body. The operation body may be an object such as a part of a user's body, a pen that a user uses or the like.

There may be various types of user's operations using operation bodies such as 1) touching an actual object with an operation body, 2) patting an actual object with an operation body, 3) tracing an actual object with an operation body, 4) holding up an operation body over an actual object and the like. For example, a user may conduct operations, which are similar to various operations conducted to icons with a mouse cursor at a common PC (clicking, double-clicking, mousing-over and the like), on an actual object.

In some aspects, a user's operation on an actual object may be an operation in which an object or a projected image is brought close to the actual object. For an operation to bring a projected image close, the information processing system 2000 may detect a user's operation (for example, a drag operation or a flick operation) conducted on a first image. For example, an operation to bring a first image close to an actual object may be an operation in which the first image is dragged and brought close to the actual object. Further, for example, an operation to bring a first image close to an actual object may be an operation in which a first image is flicked and led to an actual object (such as an operation in which the first image is tossed to the actual object).

### <<Detection Method of a User's Operation>>

For example, the operation detection unit 2080 may detect a user's operation by detecting the movement of the user's operation body or the like using a monitoring device. As the technology for detecting the movement of an operation body or the like using the monitoring device, a known technology may be applicable. For example, the operation detection unit 2080 may include a photographing device as the monitoring device, and the operation detection unit 2080 may detect a user's operation by analyzing the movement of the operation body in a photographed image.

### <<Task Execution Unit 2100>>

A task executed by the task execution unit 2100 may not especially be limited as long as the task is regarding a first image. For example, the task may be processing for displaying digital contents, processing for purchasing digital contents or the like as described in the above example.

In some aspects, the task may be processing for projecting an image representing a part or the entirety of content information associated with a first image. The content information may be information regarding a content represented by the first image, and may include, for example, the name of the content, the ID of the content, the price of the content, the explanation regarding the content, the history of the content, the browsing time of the content or the like. The task execution unit 2100 may obtain the content information corresponding to the first image from a storage unit that is provided in the information processing system 2000 or externally. Further, “content information corresponding to a first image” may be information including a first image as a part of content information. “An image representing a part or the entirety of content information” may be an image stored in advance in the storage unit as a part of content information” or may be an image that is generated by the task execution unit 2100.

The task execution unit 2100 may execute different tasks in accordance with the types of user's operations detected by the operation detection unit 2080 or may execute the same task regardless of the detected types of user's operations. In some instances, executed tasks may be different in accordance with the types of user's operations, and the information processing system 2000 may include a storage unit that may store information indicating combinations each of which is made of “a type of user's operation and a task to be executed”.

In some aspects, if actual objects are of plural types, the task execution unit 2100 may execute different tasks in accordance with the types of the actual objects. The task execution unit 2100 may obtain information regarding the detected actual objects from the actual object detection unit 2020; and may determine tasks to be executed on the basis of the obtained information. For example, in the abovementioned example, the mark 30, to which an operation for displaying a content is allocated, and a mark, to which an operation for purchasing the content is allocated, may be attached onto the tray 20. In some instances, executed tasks may be different in accordance with the types of actual objects, and the information processing system 2000 may include a storage unit that may store information indicating combinations each of which is made of “a type of user's operation and a task to be executed”. Further, as described above, in some instances, executed tasks may be different in accordance with the types of user's operations, and the information processing system 2000 may include a storage unit that may store information indicating combinations each of which is made of “a type of an actual object, a type of a user's operation, and a task to be executed”.

In some aspects, the task execution unit 2100 may take not only the types of user's operations but also the attributes of the user's operations into consideration. For example, the attributes of the user's operation may be the speeds, accelerations, durations, trajectories or the like of the operations. For example, the task execution unit 2100 may execute different tasks in accordance with the speeds of dragging operations in such away that, if the speed at which a first image is brought close to an actual object is a predetermined speed or larger, the task execution unit 2100 may execute a task 1, and if the speed is smaller than the predetermined speed, the task execution unit 2100 may execute a task 2. In some aspects, the task execution unit 2100 may determine that, “if the speed of a dragging operation is not equal to or not larger than a predetermined speed, it does not execute any task”.

If the acceleration of a flicking operation, in which a first image is brought close to an actual object, is equal to or larger than a predetermined acceleration, the task execution unit 2100 may execute a task. If the duration of an operation, in which a first image is kept close to an actual object, is equal to or longer than a predetermined duration, the task execution unit 2100 may execute a task. If the trajectory of an operation, in which a first image is brought close to an actual object, is depicted similarly to a predetermined trajectory, the task execution unit 2100 may execute a task. The “predetermined trajectory” may be an L-shaped trajectory, for example. These predetermined speed, acceleration, duration, and trajectory may be stored in advance in the storage unit included in the information processing system 2000.

In some aspects, a predetermined condition for the task to be executed may be set for each task. For example, this predetermined condition may be a condition that “a distance between the projection position of a first image and an actual object becomes within a predetermined distance” or a condition that “a condition, in which a distance between the projection position of a first image and an actual object is within a predetermined distance, continues for a predetermined time period or longer”. These predetermined conditions may be stored in the storage unit included in the information processing system 2000.

In other aspects, a combination of a user's operation to execute the task and a predetermined condition may be set for each task. For example, the task execution unit 2100 may execute a predetermined task when the information processing system 2000 detects an operation in which a first image is flicked and led to an actual object, and as a result, a distance between the projection position of a first image and an actual object is within a predetermined distance. This may be processing for realizing control that “a task is executed if a first image hits the periphery of an actual object when a first image is tosses to an actual object, and the task is not executed if the first image does not hit the periphery of the actual object”.

The distance between an actual object and a first image may be calculated, for example, on the basis of a distance and a direction from the monitoring device 200 to the actual object, and a distance and a direction from the projection device 100 to the first image. In some instances, the monitoring device 200 may measure a distance and a direction from the monitoring device 200 to the actual object. In other instances, the projection device 100 may measure a distance and a direction from the projection device 100 to a position onto which the first image is projected.

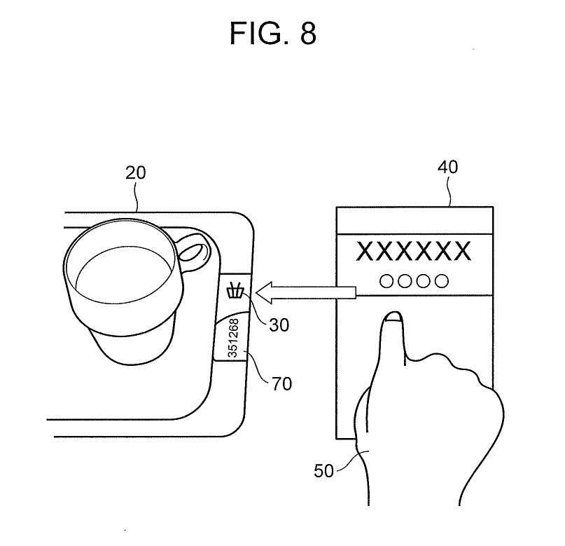

FIG. 8 is a diagram illustrating a usage state of the information processing system 2000 of the first exemplary embodiment. As illustrated in FIG. 8, a user may drag the content image 40 and may bring it close to the mark 30. When a distance between the content image 40 and the mark 30 becomes within a predetermined distance (for example, when the electronic book and the mark come into contact with each other), the task execution unit 2100 may execute a task. For example, this task may be processing for bookmarking the electronic book, processing for purchasing this electronic book. In other instances, when the content image 40 is kept at a position within a predetermined distance from the mark 30 for a predetermined time period or longer, the task execution unit 2100 may execute abovementioned tasks.

The task execution unit 2100 may obtain information regarding a projected first image in order to execute a task. The information obtained by the task execution unit 2100 may be determined on the basis of a task to be executed. For example, the task execution unit 2100 may obtain the first image itself, various attributes of the first image, content information of a content represented by the first image or the like.

For example, the task execution unit 2100 may obtain information regarding the projected first image from the image obtaining unit 2040 or from the projection unit 2060. The task execution unit 2100 may obtain information that specifies the projected first image (for example, the ID of the first image) from the image obtaining unit 2040 or the projection unit 2060 and may obtain other information regarding the specified first image from the information processing system 2000.

### Second Exemplary Embodiment

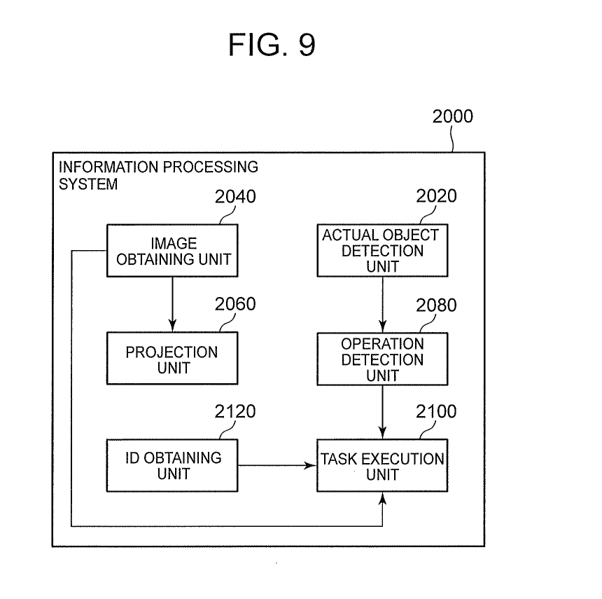

FIG. 9 is a block diagram illustrating an information processing system 2000 of a second exemplary embodiment. In FIG. 9, arrows indicate a flow of information. Each block in FIG. 9 does not indicate the configuration of a hardware unit, but indicates the configuration of a functional unit. In certain aspects, the information processing system 2000 may include an actual object detection unit 2020, an image obtaining unit 2040, a projection unit 2060, an operation detection unit 2080, a task execution unit 2100, and an ID obtaining unit 2120.

The information processing unit 2000 of the second exemplary embodiment may associate an ID corresponding to an actual object with content information corresponding to a first image. Therefore, the information processing unit 2000 of the second exemplary embodiment may include an ID information obtaining unit 2120 and an association information storage unit 2140.

### <ID Obtaining Unit 2120>

The ID obtaining unit 2120 may obtain an ID corresponding to an actual object. An ID corresponding to an actual object may be an ID allocated to the actual object or an ID allocated to the different object corresponding to the actual object ID (for example, a user ID).

There may be various methods in which the ID obtaining unit 2120 obtains an ID corresponding to an actual object. It is assumed that an ID corresponding to an actual object is an ID allocated to the actual object (referred to as an actual object ID hereinafter). In other aspects, it is assumed that the actual object displays information indicating its actual object ID. “Information indicating an actual object ID” includes, for example, a character string, a two-dimensional code, a bar code and the like. Further, “information indicating an actual object ID” may include shapes such as concaves, convexes, and notches of the surface of an actual object. The ID obtaining unit 2120 may obtain information indicating an actual object ID, and may obtain an ID corresponding to the actual object from this information. Analyzing ID which is represented by a character string, a two-dimensional code, a bar code and/or a shape, and obtaining the analyzed ID are well-known technologies. For example, there may be a technique in which an ID represented by a character string is obtained by photographing the character string by a camera, and by executing character string recognition processing on the photographed image.

“Information indicating an actual object ID” may be displayed not on the actual object but on another position. For example, “information indicating an actual object ID” may be displayed on the vicinities of the actual object.

It is assumed that an ID corresponding to an actual object is an ID allocated to the different object corresponding to an actual object ID. For example, a user ID may be “an ID allocated to the different object corresponding to an actual object ID”. In some instances, the ID obtaining unit 2120 may obtain an actual object ID using abovementioned various methods, and may obtain a user ID corresponding to the obtained actual object ID. The information processing system 2000 may include a storage unit that may store information that associates actual object IDs with user IDs.

### <Task Execution Unit 2100>

A task execution unit 2100 may execute a task that generates association information by associating the ID obtained by the ID obtaining unit 2120 with content information corresponding to a first image. A user's operation for executing this task, the attribute of the user's operation or a predetermined condition may be arbitrary. For example, the task execution unit 2100 may generate association information when an operation that brings the first image close to an actual object is detected.

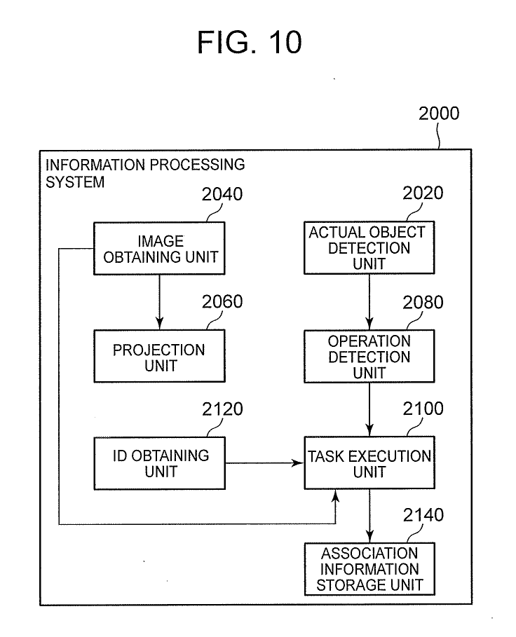

The information processing system 2000 may further include an association information storage unit 2140 as illustrated in FIG. 10. In certain aspects, the information processing system 2000 may include an actual object detection unit 2020, an image obtaining unit 2040, a projection unit 2060, an operation detection unit 2080, a task execution unit 2100, an ID obtaining unit 2120, and an association information storage unit 2140. The association information storage unit 2140 may store association information. The task execution unit 2100 may store the generated association information in the association information storage unit 2140.

### <Flow of Processing>

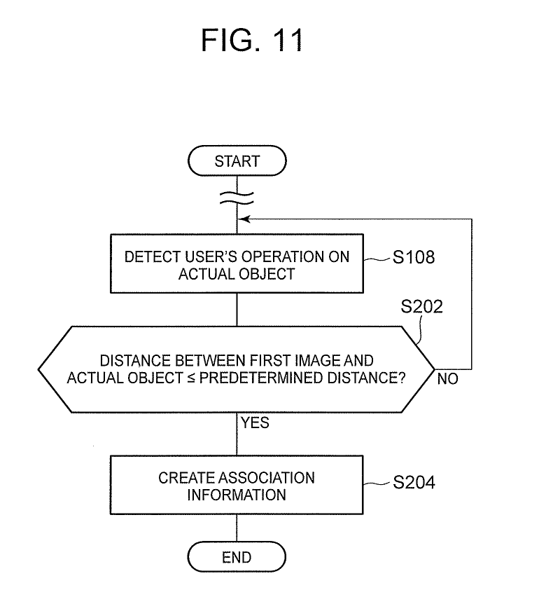

FIG. 11 is a flowchart depicting a flow of processing executed by the information processing system 2000 of the second exemplary embodiment. FIG. 11 depicts the case where a task may be executed when a condition that “a distance between a first image and an actual object≦a predetermined distance” is satisfied.

By way of example, the information processing system 2000 may be configured to perform the exemplary processes of FIG. 4 to detect an actual object by the actual object detection unit 2020 (e.g., step S102 of FIG. 4), to obtain a first image (e.g., step S104 of FIG. 4), to project the first image by the projection unit 2060 (e.g., step S106 of FIG. 4), and to detect a user's operation on the actual object by the operation detection unit 2080 (e.g., step S108 of FIG. 4).

In step S202, an operation detection unit 2080 may detect a user's operation on an actual object. In step S204, the task execution unit 2100 may determine whether or not “a distance between a first image and an actual object≦a predetermined distance” is satisfied. If “a distance between a first image and an actual object≦a predetermined distance” is satisfied (YES in step S202), the processing depicted in FIG. 11 proceeds to step S204. In step S204, the task execution unit 2100 may generate association information. On the other hand, if “a distance between a first image and an actual object≦a predetermined distance” is not satisfied (NO in step S202), the processing depicted in FIG. 11 goes back to step S108.

In the processing shown in FIG. 11, as mentioned in the first exemplary embodiment, the task execution unit 2100 may execute different tasks in accordance with the type of an actual object or the type of a user's operation. The types of actual objects and the types of user's operations that are associated with tasks that generate association information may be specified in advance in the information processing system 2000. While determining in step S202, the task execution unit 2100 may also determine whether or not the type of the user's operation conducted on the actual object or the actual object on which the user's operation is conducted is associated with a task that generates association information.

According to this exemplary embodiment, an ID corresponding to an actual object may be associated with content information corresponding to a first image in accordance with a user's operation. Therefore, it may become possible that an ID corresponding to an actual object and content information corresponding to a first image are associated with each other using an easy-to-use input interface that is an actual object.

### Second Example

A concrete usage example of the information processing system 2000 of the second exemplary embodiment will be described as a second example. The assumed environment of this example may be similar to the assumed environment of the first example.

A state on a table 10 in this example is illustrated in FIG. 8. The information processing system 2000 may associate content information of an electronic book, which a user wants to purchase, with the ID of a tray 20 to the user. The actual object may be a mark 30 attached to the tray 20. An ID corresponding to the actual object may be an ID of the tray 20. An identifier number 70 for identifying the ID of the tray 20 may be attached to the tray 20. The identifier number 70 in FIG. 8 indicates that the ID of the tray 20 is “351268”.

The user may drag a content image 40 corresponding to the electronic book that the user wants to purchase, and may bring it close to the mark 30. As a result, the task execution unit 2100 may obtain content information of the electronic book (such as the ID of the electronic book) corresponding to the content image 40, and may generate association information by associating the obtained content information with the ID of the tray 20 indicated by the identifier number 70. For example, the task execution unit 2100 may generate the association information when the content image 40 comes into contact with the mark 30. Seen from the user's viewpoint, bringing the content image 40 close to the mark 30 may be an operation that gives the feeling of “putting a content in a shopping basket” to the user. Therefore, an operation that is instinctively understandable for the user may be provided.

The information processing system 2000 may output something for informing the user that the association information has been generated. For example, the information processing system 2000 may output an animation in which the content image 40 is drawn into the mark 30, and the user may visually confirm that the electronic book corresponding to the content image 40 is associated with the tray 20.

An ID corresponding to an actual object may be made a user's ID. In some instances, a user may associate an electronic book that he/she wants to purchase with his/her own user ID by conducting the above operation. In order to make the ID corresponding to the actual object the user ID, the tray 20 may be associated with the user ID in advance. For example, when the user purchases food and drink and receives the tray 20, the user may input his/her user ID or may show his/her member's card tied to his/her user ID. Because this may enable the information processing system 2000 to recognize the user ID of this user, the information processing system 2000 can associate the user ID of the user with the tray 20 to be passed to the user.

### Third Exemplary Embodiment

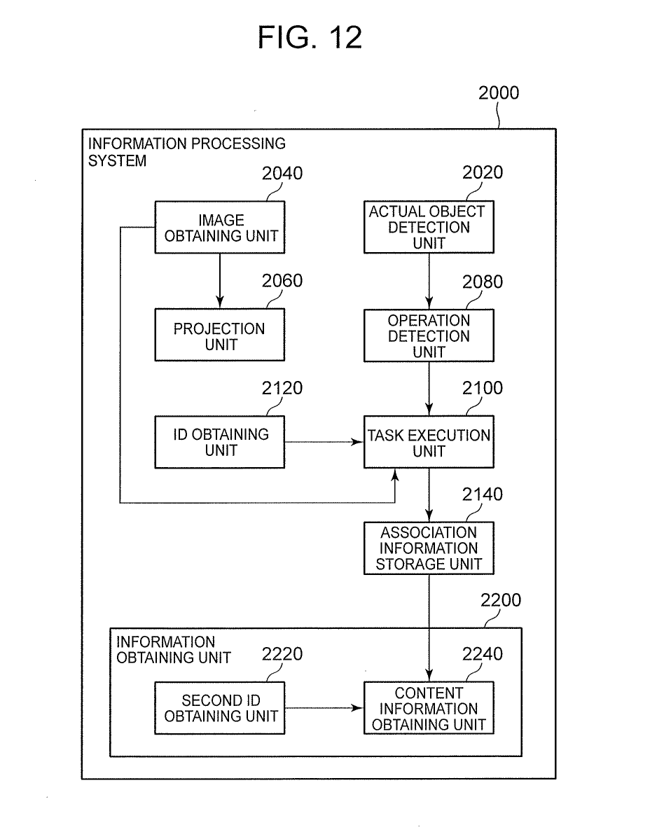

FIG. 12 is a block diagram illustrating an information processing system 2000 of a third exemplary embodiment. In FIG. 12, arrows indicate a flow of information. Each block in FIG. 12 does not indicate the configuration of a hardware unit, but indicates the configuration of a functional unit. In certain aspects, the information processing system 2000 may include an actual object detection unit 2020, an image obtaining unit 2040, a projection unit 2060, an operation detection unit 2080, a task execution unit 2100, an ID obtaining unit 2120, an association information storage unit 2140, and an information obtaining unit 2200.

In the third exemplary embodiment, an actual object may be a part or the entirety of a movable object. A part of the movable object may be a mark attached to the movable object or the like. For example, in the first example, the tray 20 may be a movable object, and the mark 30 attached to the tray 20 may be an actual object.

The information processing system 2000 of the third exemplary embodiment may include an information obtaining device 2200. With reference to an ID corresponding to an actual object, the information obtaining device 2200 may obtain content information corresponding the ID on the basis of association information generated by a task execution unit 2100. The information processing system 2000 of the third exemplary embodiment may include the association information storage unit 2140 described in the second exemplary embodiment. Hereinafter, the information obtaining device 2200 will be described in detail.

### <Information Obtaining Device 2200>

The information obtaining device 2200 may include a second ID obtaining unit 2220 and a content information obtaining unit 2240. For example, the information obtaining device 2200 may be a register terminal or the like.

### <<Second ID Obtaining Unit 2220>>

The second ID obtaining unit 2220 may obtain an ID corresponding to an actual object. There may be various methods in which the second ID obtaining unit 2220 obtains an ID corresponding to an actual object. For example, the second ID obtaining unit 2220 may obtain an ID corresponding to an actual object using a method that is the same as any of “methods in which an ID corresponding an actual object is obtained” described in the explanation regarding the ID obtaining unit 2120. However, a method of obtaining an ID corresponding to an actual object performed in the ID obtaining unit 2120 may be different from the method performed in the second ID obtaining unit 2220.

### <<Content Information Obtaining Unit 2240>>

The content information obtaining unit 2240 may obtain content information corresponding to the ID, which is obtained by the second ID obtaining unit 2220, from the association information storage unit 2140.

The content obtained by the content information obtaining unit 2240 may be used in various ways. For example, it will be assumed that the information obtaining device 2200 is a register terminal. The information obtaining device 2200 may make payment about this content using the price of a content indicated in the obtained content information.

### <Flow of Processing>

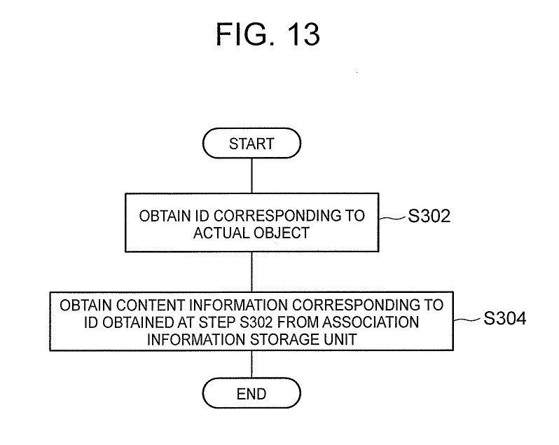

FIG. 13 is a flowchart depicting a flow of processing executed by the information obtaining device 2200 of the third exemplary embodiment. In step S302, the second ID obtaining unit 2220 may obtain an ID corresponding to an actual object. In step S304, the content information obtaining unit 2240 may obtain content information corresponding to the ID, which is obtained in step S302, from the association information storage unit 2140.

According to this exemplary embodiment, the information obtaining device 2200 may obtain an ID corresponding to an actual object, and can obtain content information corresponding to the ID. As a result, the content information, which is associated with the ID corresponding to the actual object by a user's operation, may become easy to utilize. Hereinafter, the information processing system 2000 of this exemplary embodiment will be described more in detail through an example.

### Third Example

An example of the information processing system 2000 of this exemplary embodiment will be illustrated in the same assumed environment of the second example. The information obtaining device 2200 may be a register terminal.

A user who finished his/her meal may carry his/her tray 20 to the register terminal. A clerk may obtain the ID of this tray 20 using the information obtaining device 2200. As illustrated in FIG. 8, the tray 20 may include an identifier number 70. The clerk may make the information obtaining device 2200 scan the identifier number 70. As a result, the information obtaining device 2200 may obtain the ID of the tray 20. The information obtaining device 2200 may obtain content information corresponding to the obtained ID. This content information may be content information corresponding to the content image 40, which is brought close to the mark 30 by the user, and may be content information of a content that the user wants to purchase.

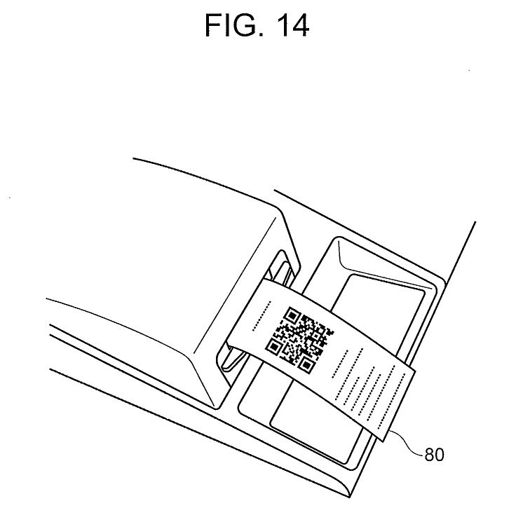

Through the above processing, the register terminal may determine the price of the content that the user wants to purchase. The user may pay the price to the clerk. As a result, the register terminal may output a ticket used for the user to download the content the user purchased. For example, the ticket may have a URL (Uniform Resource Locator) for downloading the purchased content or a password for downloading. These pieces of information may be represented in the form of character information or in the form of encoded information such as a two-dimensional code. FIG. 14 is a diagram illustrating a state of a ticket 80, which is used for downloading a content purchased at the register terminal, being output from the register terminal. The user can download the purchased content using the information indicated by the ticket 80 by means of a mobile terminal or a PC, and can use the content.

### Fourth Exemplary Embodiment

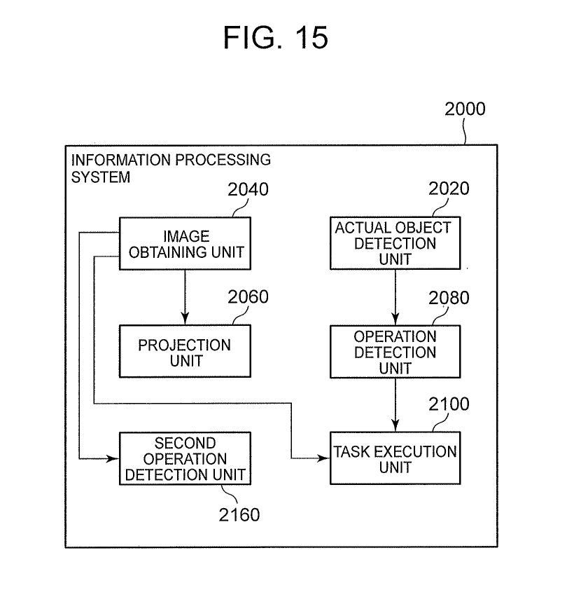

FIG. 15 is a block diagram illustrating an information processing system 2000 of a fourth exemplary embodiment. In FIG. 15, arrows indicate a flow of information. Each block in FIG. 15 does not indicate the configuration of a hardware unit, but indicates the configuration of a functional unit. In certain aspects, the information processing system 2000 may include an actual object detection unit 2020, an image obtaining unit 2040, a projection unit 2060, an operation detection unit 2080, a task execution unit 2100, and a second operation detection unit 2160.

An information processing system 2000 of the fourth exemplary embodiment may project a second image as well as a first image onto a projection surface. The information processing system 2000 may allocate operations and functions to the second image. Hereinafter, the behavior of the information processing system 2000 will be described in detail.

### <Image Obtaining Unit 2040>

An image obtaining unit 2040 of the fourth exemplary embodiment may further obtain the second image. The second image may be an image different from the first image. For example, a method in which the image obtaining unit 2040 obtains the second image may be any of plural “methods in which the first image is obtained” illustrated in the first exemplary embodiment.

### <Projection Unit 2060>

A projection unit 2060 of the fourth exemplary embodiment may further project the second image. There are many positions onto which the projection unit 2060 projects the second image. For example, the projection unit 2060 may determine a position onto which the second image is projected on the basis of a position at which an actual object is detected. For example, the projection unit 2060 may project the second image onto the vicinities of the actual object.

The actual object may be a part of an object, and the projection unit 2060 may recognize the position of the object and may determine a position onto which the second image is projected on the basis of the position of the object. For example, it will be assumed that the actual object is a mark 30 attached to a tray 20 as illustrated in FIG. 6 or FIG. 8. In some instances, for example, the projection unit 2060 may project the second image onto the inside of the tray 20 or onto the vicinities of the tray 20.

In some aspects, the projection unit 2060 may determine the position onto which the second image is projected regardless of the position of the actual object. For example, the projection unit 2060 may project the second image onto a predetermined position inside a projection surface. The projection unit 2060 may project the second image onto the position set in advance by the projection unit 2060 itself, or the position stored in a storage unit that the projection unit 2060 can access.

### <Second Operation Detection Unit 2160>

A second operation detection unit 2160 may detect a user's operation on the first image or on the second image. The user's operation conducted on the first image or on the second image may be similar to the user's operation described in the first exemplary embodiment. A task execution unit 2100 of the fourth exemplary embodiment may execute a task regarding the first image when an operation for bringing the first image and the second image close to each other is detected.

“The operation for bringing the first image and the second image close to each other” may be “an operation for bringing the first image close to the second image” or “an operation for bringing the second image close to the first image”. These operations may be similar to “the operation for bringing a first image close to an actual object” described in the first exemplary embodiment. For example, “the operation for bringing the first image and the second image close to each other” may be an operation for dragging or flicking the first image toward the second image.

The task execution unit 2100 may further take various attributes of the user's operation detected by the second operation detection unit 2160 into consideration as is the case with the user's operation described in the first exemplary embodiment. For example, the task execution unit 2100 may execute a task when the first image is flicked toward the second image with acceleration equal to or larger than predetermined acceleration. The task execution unit 2100 of the fourth exemplary embodiment can execute a task in the case where the various predetermined conditions described in the first exemplary embodiment are satisfied as a result of the user's operation detected by the second operation detection unit 2160. For example, the task execution unit 2100 may execute a task if a distance between the projection position of the first image and the projection position of the second image becomes within a predetermined distance as a result of the first image being flicked toward the second image.

### <Flow of Processing>

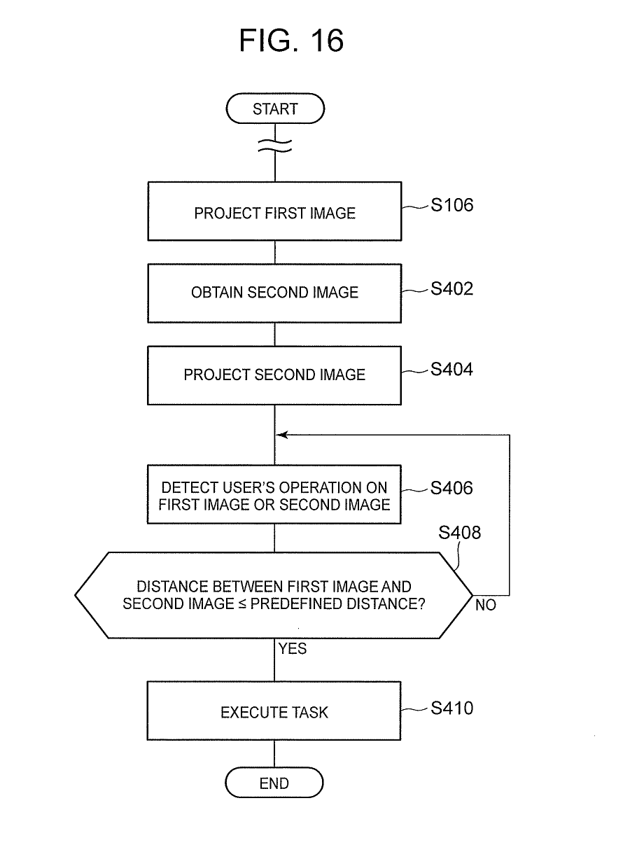

FIG. 16 is a flowchart depicting a flow of processing executed by the information processing system 2000 of the fourth exemplary embodiment. FIG. 16 depicts a case where a task is executed when a condition of “a distance between a first image and a second image≦a predetermined distance” is satisfied.

By way of example, the information processing system 2000 may be configured to perform the exemplary processes of FIG. 4 to detect an actual object by the actual object detection unit 2020 (e.g., step S102 of FIG. 4), to obtain a first image (e.g., step S104 of FIG. 4), and to project the first image by the projection unit 2060 (e.g., step S106 of FIG. 4).

In step S402, the image obtaining unit 2040 may obtain a second image. In step S404, the projection unit 2060 may project the second image. In step S406, the second operation detection unit 2160 may detect the user's operation on the first image or on the second image.

In step S408, the task execution unit 2100 may determine whether or not the condition “a distance between a first image and a second image≦a predetermined distance” is satisfied. If the condition “a distance between a first image and a second image≦a predetermined distance” is satisfied (YES in step S408), the processing depicted in FIG. 16 proceeds to step S410. In step S410, the task execution unit 2100 may execute the task. On the other hand, in step S408, if the condition “a distance between a first image and a second image≦a predetermined distance” is not satisfied (NO in step S408), the processing depicted in FIG. 16 goes back to step S406.

According to this exemplary embodiment, as interfaces for executing the task regarding the first image, an operation on the first image or on the second image may be provided in addition to the operation on the actual object. Therefore, a variety of operations may be provided to a user as operations for executing the task regarding the first image. A task executed by the task execution unit 2100 upon detecting a user's operation by the second operation detection unit 2160 may be different from a task executed by the task execution unit 2100 upon detecting a user's operation by the operation detection unit 2080. This may make it possible to provide a larger variety of operations to a user.

The second image may be projected onto the vicinities of an actual object. As described in the first exemplary embodiment, if an actual object is made an input interface, this may bring about the advantage in that the position of the input interface becomes easy to grasp. Therefore, if the second image is projected onto the vicinities of an actual object, the position of the second image projected onto the vicinities of the actual object, the position of which can be easily grasped, also becomes easy to grasp. Therefore, it may become easy to conduct an operation on the second image.

### Fifth Exemplary Embodiment

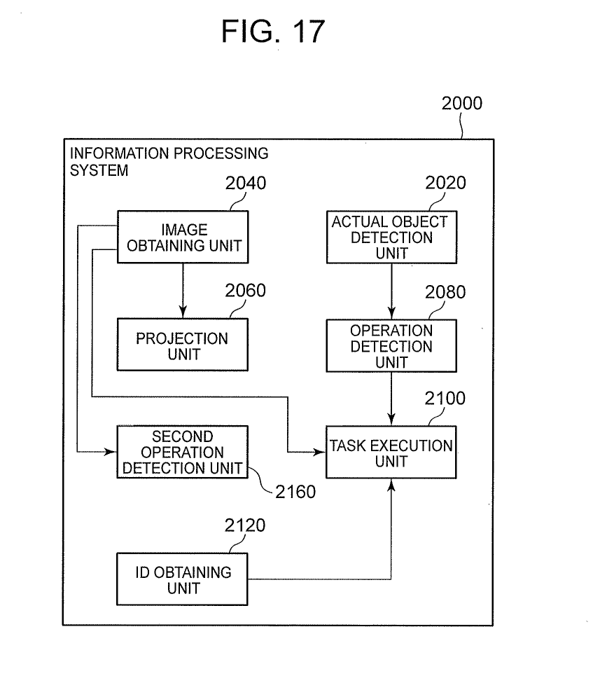

FIG. 17 is a block diagram illustrating an information processing system 2000 of a fifth exemplary embodiment. In FIG. 17, arrows indicate a flow of information. Each block in FIG. 17 does not indicate the configuration of a hardware unit, but indicates the configuration of a functional unit. In certain aspects, the information processing system 2000 may include an actual object detection unit 2020, an image obtaining unit 2040, a projection unit 2060, an operation detection unit 2080, a task execution unit 2100, an ID obtaining unit 2120, and a second operation detection unit 2160.

The information processing system 2000 of the fifth exemplary embodiment may be different from the information processing system 2000 of the fourth exemplary embodiment in that the information processing system 2000 of the fifth exemplary embodiment includes an ID obtaining unit 2120. The ID obtaining unit 2120 may be similar to the ID obtaining unit 2120 included in the information processing system 2000 of the second exemplary embodiment.

A task execution unit 2100 of the fifth exemplary embodiment may execute a task for generating the abovementioned association information using an ID corresponding to an actual object obtained by the ID obtaining unit 2120. Concretely, if a distance between the projection position of a first image and the projection position of a second image is within a predetermined distance upon detecting a user's operation by a second operation detection unit 2160, the task execution unit 2100 of the fifth exemplary embodiment may generate the association information by associating the ID obtained by the ID obtaining unit 2120 with content information corresponding to the first image.

A method in which the ID obtaining unit 2120 of the fifth exemplary embodiment may obtain the ID corresponding to the actual object is similar to the method performed by the ID obtaining unit 2120 of the second exemplary embodiment. A method, in which the task execution unit 2100 of the fifth exemplary embodiment obtains the content information corresponding to the first image, may be similar to the method performed by the task execution unit 2100 of the second exemplary embodiment.

For example, the task execution unit 2100 of the fifth exemplary embodiment may transmit the generated association information to an external device. For example, the external device may be a server computer in a system that provides services to users in cooperation with the information processing system 2000 or the like.

According to this exemplary embodiment, if a distance between the projection position of a first image and the projection position of a second image is within a predetermined distance upon detecting a user's operation by the second operation detection unit 2160, association information which associates an ID corresponding to an actual object with content information corresponding to the first image may be generated. This association information may be transmitted, for example, to a system that provides services to users in cooperation with the information processing system 2000 and the like as described above. This may make it possible for the information processing system 2000 to cooperate with other systems, so that a larger variety of services can be provided to users. Hereinafter, the information processing system 2000 of this exemplary embodiment will be described more in detail through an example.

### Fourth Example

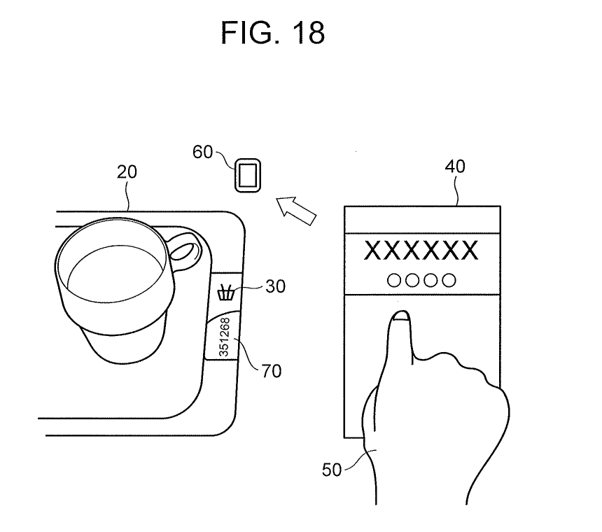

Assuming that a usage environment similar to that of the first exemplary embodiment is used, an example of the information processing system 2000 of this exemplary embodiment will be described. FIG. 18 is a plan view illustrating a state on a table 10. The second image may be a terminal image 60 that is an image schematically showing a mobile terminal.

A user can browse information regarding an electronic book corresponding to a content image 40 at the user's mobile terminal by bringing the content image 40 close to the terminal image 60. In some aspects, the information processing system 2000 can provide an operation, by which the terminal image 60 is moved, to the user. In other aspects, it is also possible that the user moves the terminal image 60 and brings it close to the content image.

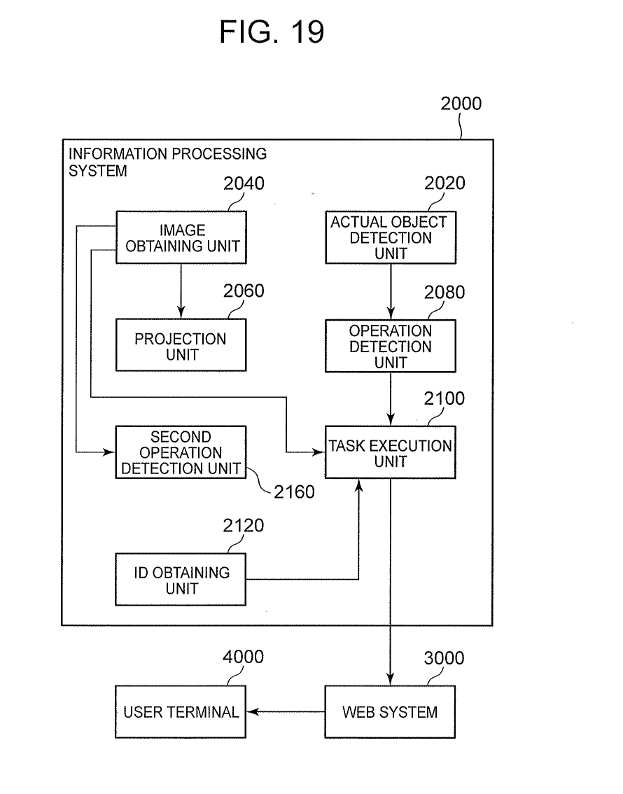

Because the information processing system 2000 is made to work with a mobile terminal in this way, the information processing system 2000 of this example may cooperate with a Web system which a user's mobile terminal can access. FIG. 19 is a block diagram illustrating a combination of the information processing system 2000 and the Web system 3000. Hereinafter, a flow in which the information processing system 2000 and the Web system 3000 may work in cooperation with each other will be illustrated. Cooperative work to be described below is illustrative, so no other flow in which the information processing system 2000 and the Web system 3000 work in cooperation with each other may be limited to the example below.

The information processing system 2000 may generate association information when the information processing system 2000 detects that a distance between the projection position of a first image and the projection position of a second image becomes within a predetermined distance. The information processing system 2000 of this example may use a user ID as an ID corresponding to an actual object. The information processing system 2000 may obtain a content ID as content information. Therefore, the information processing system 2000 may generate association information composed of a combination of “a user ID and a content ID”.

The information processing system 2000 may transmit the generated association information to the Web system 3000 with which the information processing system 2000 cooperates. Generally speaking, a Web system may require the information processing system 2000 to input a password as well as a user ID. In some aspects, the information processing system 2000 may transmit the password as well as the association information. A user may input “a user ID and a password” in advance at a register terminal, for example, when he/she receives a tray 20. Further, for example, the information processing system 2000 may detect that a distance between the projection position of the first image and the projection image of the second image is within the predetermined distance, and the information processing system 2000 may project the image of a keyboard or the like onto a projection surface and may request the input of a password. The information processing system 2000 may obtain the password by detecting an input made to the image of the keyboard or the like. The information processing system 2000 may transmit a combination of “the user ID, the electronic book, and the password” to the Web system 3000.

The Web system 3000, which receive the information from the information processing system 2000, may tie the electronic book to a user account (a combination of the user ID and the password) if the user account is correct.

The Web system 3000 may provide a Web service that can be accessed via browsers. A user may browse content information tied to a user account of his/her own by performing login to this Web service using the browser of his/her mobile terminal. In the abovementioned example, the user can browse information of the electronic book displayed by the content image 40 that is brought close to the terminal image 60. An application for accessing the Web system 3000 may not be limited to a general-purpose browser, and for example, it may be a dedicated application.

For example, this Web service may provide services such as an online payment to the user. This may make it possible for the user to purchase a content corresponding to the content image 40 that the user is browsing on the table 10 through online payment using his/her mobile terminal.

Because such a service as above is provided, a user can browse contents while having a meal, and if there is a favorite content, the user can browse or purchase the content through a simple operation using a mobile terminal or the like. Therefore, the information processing system 2000 may improve of the convenience and may increase of the advertising effect.

Although the embodiments of the present disclosure have been described with reference to the drawings as above, these are examples and the present disclosure can be realized by adopting various configurations other than the abovementioned configurations. The examples of referential embodiments will be appended below.

### (Supplementary Note 1)

An information processing system including:

a memory storing instructions; and

at least one processor configured to process the instructions to:

detect an actual object;

project a first image;

detect a user's operation on the actual object; and

execute a task regarding the first image on the basis of the user's operation.

### (Supplementary Note 2)

The information processing system according to supplementary note 1, wherein the at least one processor is configured to process the instructions to:

obtain an ID corresponding to the actual object,

generate association information by associating the obtained ID with content information corresponding to the first image.

### (Supplementary Note 3)

The information processing system according to supplementary note 1, wherein the at least one processor is processors are configured to process the instructions to project an image that represents a part or the entirety of the content information corresponding to the first image.

### (Supplementary Note 4)

The information processing system according to supplementary note 1, wherein the at least one processor is configured to process the instructions to:

execute the task in at least one of the following cases:
the case where the first image is brought close to the actual object by a predetermined user's operation,
the case where a distance between the projection position of the first image and the actual object becomes within a predetermined distance,
the case where a condition, in which a distance between the projection position of the first image and the actual object is within a predetermined distance, continues for a predetermined time period or longer, and
the case where a predetermined user's operation continues for a predetermined time period or longer.

### (Supplementary Note 5)

The information processing system according to supplementary note 4,

wherein the actual object is a part or the entirety of a movable object;

wherein the at least one processor is configured to process the instructions to store the association information; and

wherein the information processing system includes an information obtaining device; and

the information obtaining device includes:
a memory storing instructions; and
at least one processor configured to process the instructions to:
   obtain a second ID corresponding to the actual object; and
   obtain the content information corresponding to the second ID, based on the stored association information.

### (Supplementary Note 6)

The information processing system according to supplementary note 1, wherein the at least one processor is configured to process the instructions to:

further project a second image;

detect a user's operation on the first image or on the second image; and

execute a task regarding the first image in the case where an operation brings the first image and the second image close to each other.

### (Supplementary Note 7)

The information processing system according to supplementary note 6, wherein the at least one processor is configured to process the instructions to:

photograph the actual object;

obtain an ID corresponding to the actual object from the photographing result,

generate association information by associating the obtained ID with content information corresponding to the first image in the case where an operation brings the first image and the second image close to each other.

### (Supplementary Note 8)

The information processing system according to supplementary note 7, wherein the at least one processor is configured to process the instructions to transmit the generated association information to an external device.

### (Supplementary Note 9)

An information processing method including:

detecting an actual object;

projecting a first image;

detecting a user's operation on the actual object; and

executing a task regarding the first image on the basis of the user's operation.

### (Supplementary Note 10)

The control method according to supplementary note 9, including

obtaining an ID corresponding to the actual object; and

generating association information by associating the obtained ID with content information corresponding to the first image.

### (Supplementary Note 11)

The control method according to supplementary note 9, including

projecting an image that represents a part or the entirety of the content information corresponding to the first image.

### (Supplementary Note 12)

The control method according to supplementary note 9, including

executing the task in at least one of the following cases:
the case where the first image is brought close to the actual object by a predetermined user's operation,
the case where a distance between the projection position of the first image and the actual object becomes within a predetermined distance,
the case where a condition, in which a distance between the projection position of the first image and the actual object is within a predetermined distance, continues for a predetermined time period or longer, and
the case where a predetermined user's operation continues for a predetermined time period or longer.

### (Supplementary Note 13)

The control method according to supplementary note 12,

wherein the actual object is a part or the entirety of a movable object, and including

storing the association information, obtaining a second ID corresponding to the actual object; and

obtaining the content information corresponding to the second ID, based on the stored association information.

### (Supplementary Note 14)

The control method according to supplementary note 9, including

further projecting a second image;

detecting a user's operation on the first image or on the second image; and

executing a task regarding the first image in a case where an operation brings the first image and the second image close to each other.

### (Supplementary Note 15)

The control method according to supplementary note 14, including

photographing the actual object;

obtaining an ID corresponding to the actual object from the photographing result; and

generating association information by associating the obtained ID with the content information corresponding to the first image in the case where an operation brings the first image and the second image close to each other.

### (Supplementary Note 16)

The control method according to supplementary note 15, including transmitting the generated association information to an external device.

### (Supplementary Note 17)

A non-transitory computer-readable storage medium storing instructions that when executed by a computer enable the computer to implement a method including:

detecting an actual object;

projecting a first image;

detecting a user's operation on the actual object; and

executing a task regarding the first image on the basis of the user's operation.

### (Supplementary Note 18)

The non-transitory computer-readable storage medium according to supplementary note 17, including

obtaining an ID corresponding to the actual object; and

generating association information by associating the obtained ID with content information corresponding to the first image.

### (Supplementary Note 19)

The non-transitory computer-readable storage medium according to supplementary note 17, including

projecting an image that represents a part or the entirety of the content information corresponding to the first image.

### (Supplementary Note 20)

The non-transitory computer-readable storage medium according to supplementary note 17, including

executing the task in at least one of the following cases:
the case where the first image is brought close to the actual object by a predetermined user's operation,
the case where a distance between the projection position of the first image and the actual object becomes within a predetermined distance,
the case where a condition, in which a distance between the projection position of the first image and the actual object is within a predetermined distance, continues for a predetermined time period or longer, and
the case where a predetermined user's operation continues for a predetermined time period or longer.

### (Supplementary Note 21)

The non-transitory computer-readable storage medium according to supplementary note 20,

wherein the actual object is a part or the entirety of a movable object, and including

storing the association information, obtaining a second ID corresponding to the actual object; and

obtaining the content information corresponding to the second ID, based on the stored association information.

### (Supplementary Note 22)

The non-transitory computer-readable storage medium according to supplementary note 17, including

further projecting a second image;

detecting a user's operation on the first image or on the second image; and

executing a task regarding the first image in the case where an operation brings the first image and the second image close to each other.

### (Supplementary Note 23)

The non-transitory computer-readable storage medium according to supplementary note 22, including

photographing the actual object;

obtaining an ID corresponding to the actual object from the photographing result; and

generating association information by associating the obtained ID with the content information corresponding to the first image in the case where an operation brings the first image and the second image close to each other.

### (Supplementary Note 24)

The non-transitory computer-readable storage medium according to supplementary note 23, including transmitting the generated association information to an external device.

What is claimed is:

1. An information processing system comprising:
a memory storing instructions; and
at least one processor configured to process the instructions to:
detect an actual object;
project a first image;
detect a user's operation on the actual object; and
execute a task regarding the first image on the basis of the user's operation.

2. The information processing system according to claim 1, wherein the at least one processor is configured to process the instructions to:
obtain an ID corresponding to the actual object,
generate association information by associating the obtained ID with content information corresponding to the first image.

3. The information processing system according to claim 1, wherein the at least one processor is configured to process the instructions to project information corresponding to the first image.

4. The information processing system according to claim 1, wherein the at least one processor is configured to process the instructions to:
execute the task in at least one of the following cases:
a case where the first image is brought close to the actual object by a predetermined user's operation,
a case where a distance between a projection position of the first image and the actual object becomes within a predetermined distance,
a case where a condition, in which a distance between the projection position of the first image and the actual object is within a predetermined distance, continues for a predetermined time period or longer, and
a case where a predetermined user's operation continues for a predetermined time period or longer.

5. The information processing system according to claim 4,
wherein the actual object is at least a part of a movable object;
wherein the at least one processor is configured to process the instructions to store the association information; and
wherein the information processing system comprises an information obtaining device; and
the information obtaining device includes:
a memory storing instructions; and
at least one processor configured to process the instructions to:
obtain a second ID corresponding to the actual object; and
correspond the content information to the second ID, based on the stored association information.

6. The information processing system according to claim 1, wherein the at least one processor is configured to process the instructions to:
further project a second image;
detect a user's operation on the first image or on the second image; and
execute a task regarding the first image in a case where an operation brings the first image and the second image close to each other.

7. The information processing system according to claim 6, wherein the at least one processor is configured to process the instructions to:
take a photograph of the actual object;
obtain an ID corresponding to the actual object based on the photograph; and
generate association information by associating the obtained ID with content information corresponding to the first image when the first image and the second image are brought close to each other.

8. The information processing system according to claim 7, wherein the at least one processor is configured to process the instructions to transmit the generated association information to an external device.

9. An information processing method comprising:
detecting an actual object;
projecting a first image;
detecting a user's operation on the actual object; and
executing a task regarding the first image on the basis of the user's operation.

10. A non-transitory computer-readable storage medium storing instructions that when executed by a computer enable the computer to implement a method comprising:
detecting an actual object;
projecting a first image;
detecting a user's operation on the actual object; and
executing a task regarding the first image on the basis of the user's operation.

11. The information processing system according to claim 1, comprising
a projector that adjusts a position of the first image by changing at least one of direction and position of projected light.

12. The information processing system according to claim 11, comprising a monitor that detects the actual object.

13. The information processing system according to claim 11, wherein the projector adjusts the position of the first image in accordance with the detected user's operation.

14. The information processing system according to claim 1, wherein the projector adjusts a position of the first image by masking at least part of projecting light.
